(19) United States
(12) Patent Application Publication
(10) Pub. No.: US 2026/0177844 A1
(43) Pub. Date: Jun. 25, 2026

(54) HEADSET WITH SIDE DIMMERS

(71) Applicant: Flexenable Technology Limited, Cambridge (GB)

(72) Inventors: Erin Alice McDowell, Cambridge (GB); Paul Alan Cain, Cambridge (GB)

(21) Appl. No.: 19/428,835

(22) Filed: Dec. 22, 2025

(30) Foreign Application Priority Data
Dec. 23, 2024 (GB) 2418947.4

(51) Int. Cl. G02C 11/00; G02B 26/08; G02B 27/01

(52) U.S. Cl. CPC G02C 11/12; G02B 26/0833; G02B 27/0101

(57) ABSTRACT

There is disclosed an optical device for a headset assembly which is for mounting to a head of a user, the optical device being a side shield for the headset which varies the peripheral light entering the headset.

### CROSS-REFERENCE TO RELATED APPLICATION

This patent application claims priority to Great Britain Patent Application No. 2418947.4, filed Dec. 23, 2024, which is incorporated by reference in its entirety.

### BACKGROUND

The present application relates to a headset assembly comprising side dimmers, preferably with at least one optical element, an apparatus comprising the assembly, a processor, a storage comprising instructions for controlling the device, and a method of operating such an assembly.

Augmented reality (AR), and virtual reality (VR), devices provide a digital virtual image to the eye. In the case of a VR device, or an AR device used in a VR mode, it can be advantageous to have the real world obscured in order to enhance the feeling of immersion. Light blockers may be provided in such a headset to block peripheral light.

In some cases, an individual may be required to have situational awareness and to see the real world in peripheral vision. A user may remove light blockers to achieve this.

### BRIEF DESCRIPTION OF THE DRAWINGS

FIG. 1 shows a representation of an example of a headset equipped with side dimmers;

FIG. 2 shows a representation of an example of a system architecture controlling a headset equipped with side dimmers such as shown in FIG. 1;

FIG. 3 shows a representation of a first example implementation of a side dimmer;

FIG. 4 shows a representation of a second example implementation of a side dimmer;

FIG. 5 shows a representation of an example of a headset incorporating a liquid crystal, adaptive optical lens;

FIG. 6 shows a representation of an example of a system for operating the headset of FIG. 4; and

FIG. 7 shows schematically a representation of an example apparatus. There is provided an optical device for a headset assembly which is for mounting to a head of a user, the optical device being a side shield for the headset which varies the peripheral light entering the headset.

### DETAILED DESCRIPTION

The side shield may be a controllable optical device. The optical device may be controllable to vary the transmission of peripheral light entering the headset.

The optical device may comprise a dimming film mounted on a substrate, the dimming film being controllable to vary the transmission of light. An antireflective coating and/or a hard coat may be formed on either side of the dimming film.

The dimming film may be formed on a substrate. The substrate may be curved.

The optical device may comprise a liquid crystal layer disposed between first and second electrodes, a potential applied between the first and second electrodes determining the transmission of light in the optical device. One of the first and second electrodes may comprise a plurality of individually addressable electrodes, such that the transmission of light may be controlled differently in different regions of the liquid crystal material.

A headset may include two optical devices, each positioned at a side of the headset, the headset further comprising one or more optical lens in a field of a view of an eye of a user of the headset. The headset may further comprise a left lens in the field of view of a left eye of the user and a right lens in a field of view of a right eye of the user. The headset may further comprise a controller for controlling the two optical devices positioned at each side of the headset independently to controlling the left lens and the right lens.

There is provided an assembly comprising: an optical device for a headset assembly which is for mounting to a head of a user, the optical device being a side shield for the headset which varies the peripheral light entering the headset; and at least one further optical element.

The at least one further optical element may be an optical device in a field of view of a user of the headset. The at least one further optical element may comprise at least one of: a waveguide, a luminance adjustment component, a lens, an image generation device, a reflection-reduction layer, or a protective layer.

A headset may comprise the assembly.

There is provided apparatus comprising: an optical device for a headset assembly which is for mounting to a head of a user, the optical device being a side shield for the headset which varies the peripheral light entering the headset; at least one processor; and at least one storage comprising instructions, the instructions configured to, with the at least one processor, cause the apparatus to control one or more properties of a liquid crystal, LC, layer of the optical device.

The apparatus may be configured to be mounted on a human head with a further optical device cell stack positioned in a field of view of an eye of the human head. The apparatus may further comprise a first lens comprising a first one of the LC layer and first electrode, and a second lens comprising a second one of the LC layer and first electrode. The field of view of the eye may be a first field of view of a first eye, and the first lens is configured to be positioned in the first field of view, in use, and the second lens is configured to be positioned in a second field of view, of a second human eye of the human head, in use.

There may be at least one of an augmented reality display device, a virtual reality display device, or a mixed reality display device.

The side shield may be controlled in dependence on one or more of: an ambient light in an environment in which the headset is used; a light level in a periphery of the headset; a user control input; an application running in the headset; content being viewed in the headset; a location of the headset; a date; or a time of day.

There is provided a method of operating an optical device for a headset assembly which is for mounting to a head of a user, the optical device being a side shield for the headset which varies the peripheral light entering the headset, the method comprising: selectively controlling a light transmission of the optical device.

The headset assembly may further include a further optical device in the field of view of the user when the headset if mounted to the head of the user, the method comprising controlling the optical device being the side shield and the further optical device independently.

In the above, many different aspects have been described. It should be appreciated that further aspects may be provided by the combination of any two or more of the aspects described above.

Various other aspects are also described in the following detailed description and in the attached claims.

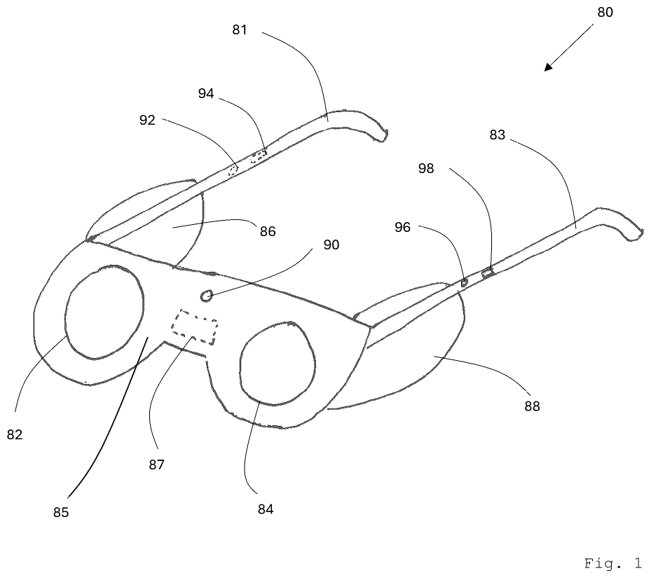

With reference to FIG. 1, there is illustrated an exemplary headset apparatus 80 generally comprising a frame including a left arm 83, a right arm 81, and a face frame 85.

The face frame 85 houses a left eye lens 84 and a right eye lens 82. In an example a left side shield 88 may be attached to the left arm 83 and adjoin the face frame 85. In an example a right eye shield 86 may be attached to the right arm 81 and adjoin the face frame 85. The light shields may be integrated into the headset apparatus 80 or may be detachable from the headset apparatus 80. The light shields may be above and/or below the eyes and/or the left and right arms, may be one continuous piece all the way round the headset, may be one continuous piece which piece forms part of the left and rights arms, or may be separate pieces above and below the arms. The purpose of the side shields is to control the level of peripheral light entering the headset from the respective side, as discussed below.

In an example an ambient light sensor 90 may be positioned in the face frame 85, between the right eye lens 82 and the left eye lens 84. In an example a left side light sensor 96 may be located in the left arm 83 of the headset. In an example, a right side light sensor 92 may be located in the right arm 83. There may be more lights sensors, there may be only one light sensor, or there may be no light sensors.

A left side user input control 98 may be located in the left arm of the headset. A right side user input control 94 may be located in the right arm 81.

Control circuitry, including a processor and a memory, may be located in the face frame 85.

The elements shown in FIG. 1, and their position, is exemplary. In particular, the sensors and input control elements may be provided in different locations, one or all of which may be omitted, or additional sensors or control inputs may be included.

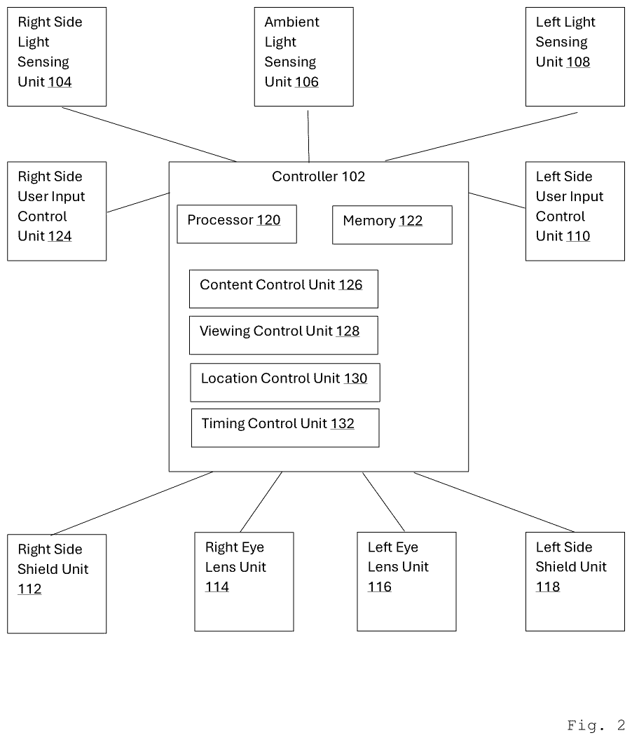

With reference to FIG. 2, there is illustrated an exemplary architecture for an apparatus utilizing side control, such as an apparatus utilizing variable side dimmers for headsets, such as the headset apparatus 80 of FIG. 1.

In an example, the architecture 100 includes a controller 102 comprising a processor 120, a memory 124, a content control unit 126, a viewing control unit 128, a location control unit 130, and a timing control unit 132.

In an example, the controller 102 receives signals from a right side light sensing unit 104, a left side light sensing unit 108, an ambient light sensing unit 106, a left side user input control unit 110, and a right side user input control unit 124.

In an example, the controller 102 generates signals to a right side shield unit 112, a right eye lens unit or light engine optics 114, a left eye lens unit or light engine optics 116, and left side shield unit 118.

In an example, the controller 102 operates to control the right eye lens unit 114 positioned in front of a user's right eye and the left eye lens unit 116 positioned in front of a user's left eye, in accordance with the implementation associated with the headset apparatus 80, for example, augmented reality (AR), virtual reality (VR), etc. The processor 120 and memory 122, and other elements of the controller 102, operate to control the left eye and right eye lens units 114,116 as necessary.

In addition, the controller 102 operates to control the right side shield unit 112 and the left eye shield unit 118 either together or independently.

The left and right side shield units 112,118 are controllable optical elements. These optical elements are controlled to control the light transmission from outside the headset to inside the headset, on the left and right sides of the user respectively. These optical elements therefore provide dimming functionality to allow a range of light to pass through. In the extreme the range is from allowing all light (100%) to pass through to allowing no light (0%) to pass through.

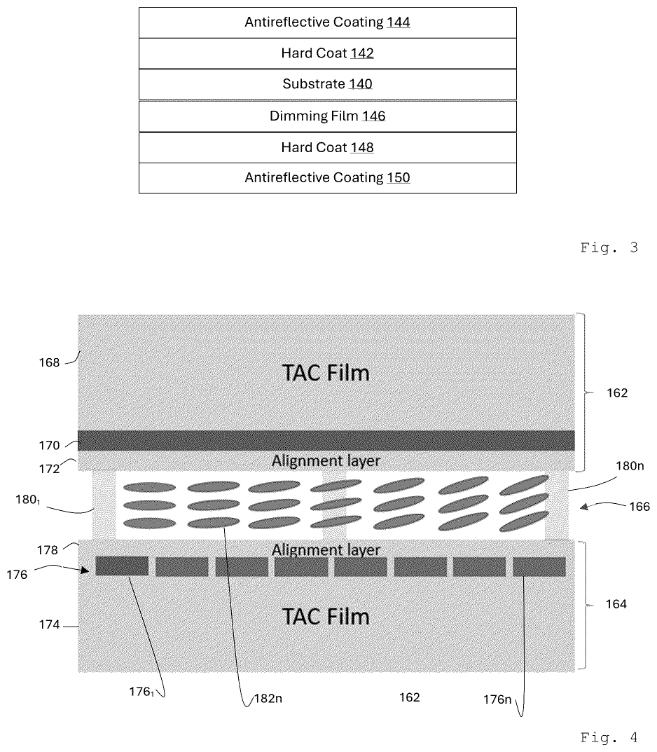

FIG. 3 is an exemplary implementation of an optical element for implementation of either the left or right side shield units 112,118. Whilst one particular dimming technology is described, based on a liquid crystal layer, this is exemplary only, and many other dimming technologies may be used, for example, electrochromic, suspended particle devices (SPD), polymer dispersed liquid crystal (PDLC), or electrophoretic.

The optical element may comprise a substrate layer 140, which may be tri acetate cellulose (TAC), polyethylene terephthalate (PET), glass, or another transparent polymer. The substrate is illustrated in FIG. 3 as flat but may be curved. The shape of the substrate is determined by the implementation of the side shield.

One surface of the substrate layer 140 may have deposited thereon an optional hard coat layer 142 and may be provided with an optional antireflective coating 144 (applied to the hard coat layer 142 where present, or else applied to the substrate layer 140).

A dimming film 146 is applied to the other surface of the substrate layer 140. The dimming film may be a liquid crystal (LC) layer, an electrochromic layer, an electrophoretic layer, etc.

The other surface of the dimming film 146 may have deposited thereon an optional hard coat layer 148 and may be provided with an optional antireflective coating 150 (applied to the hard coat layer 148 where present, or else applied to the dimming layer 146).

FIG. 4 is a further exemplary implementation, which illustrates in more detail an example electrode structure of an example segmented dimmer, which may be used to achieve dimming. Side shields 86,88 may be implemented in accordance with the structure of FIG. 4, in an example.

The example segmented dimmer includes a liquid crystal layer 166, including liquid crystal molecules 182n. Either side of the liquid crystal layer 166 there is provided a top plate 162 and a bottom plate 164. A plurality of spacers 1801 to 180n are deployed in the liquid crystal layer 166 to maintain a gap between the bottom and top plates 164,162.

The example top plate 162 includes an alignment layer 172 adjacent the liquid crystal layer 166, an electrode layer 170 adjacent the alignment layer 172, and a TAC (tri-acetyl cellulose) film 168 adjacent the electrode layer 170. The electrode layer 170 may be an indium tin oxide (ITO) layer.

The example bottom plate 164 includes an alignment layer 178 adjacent the liquid crystal layer 166, an electrode layer 176 adjacent the alignment layer 178, and a TAC (tri-acetyl cellulose) film 174 adjacent the electrode layer 176. The electrode layer 170 may be an indium tin oxide (ITO) layer.

A voltage is applied across the electrode 170 and the electrode layer 176 in order to control dimming and the transmission of light through the LC layer 166.

In the illustrated example, the electrode layer 176 is formed of a plurality of conductive strips 1761 to 176n. To control dimming, a common voltage may be applied to each electrode strip, or a different voltage may be applied to some or all electrode strips.

Alternative structures of the electrode layer 176 may be implemented. The electrode layer 176 may be a plurality of pixels which may be individually driven, or a plurality of zones each including a plurality of pixels, which zones may be individually driven. Tens or pixels or a few hundred pixels may be independently controlled. The pixels or zones may form any shape, e.g., squares, hexagons.

Yet another alternative structure of the electrode layer 176 is an active-matrix of pixels, each driven by a TFT (thin film transistor), allowing thousands or more pixels to be independently controlled.

In general, there is no limitation to the dimming technology, or structure to implement dimming functionality, including electrode design.

Each of the right eye lens unit 112 and the left eye lens unit 116 may include a segmented dimmer such as shown in FIG. 4, the voltage applies to the electrodes in such a segmented dimmer being controlled by the controller 102.

The operation of the improved headset in an example, and in particular, the control of the dimming functionality of the side shields 86,88, is described further with reference to FIG. 2.

In this example, the optional ambient light sensor unit 106 is configured to sense ambient light in the environment in which the headset apparatus 80 is being used and provide a measure of the ambient light to the controller 102. This measure may be an indication of the ambient brightness. In response to this measure of the ambient light, the controller 102 may control the dimming provided by one or both of the right and left sided shield units 112,118. The headset apparatus may be equipped with more than one ambient light sensor, and the processor may control the dimming provided by one or both of the right and left sided shield units 112,118 in dependence on an average from multiple sensors. The processor may control the dimming provided by one or both of the right and left sided shield units 112,118 in dependence on an ambient light measure detected on the respective side.

The optional right light sensor unit 104 is configured to sense the light at the right side of the headset apparatus and provide a measure of the light level light to the controller 102. This measure may be an indication of brightness. In response to this measure of the right side light, the controller 102 may control the dimming provided by the right sided shield unit 112.

The optional left light sensor unit 108 is configured to sense the light at the left side of the headset apparatus and provide a measure of the light level light to the controller 102. This measure may be an indication of brightness. In response to this measure of the left side light, the controller 102 may control the dimming provided by the left sided shield unit 118.

In other examples there may not be any light sensor.

The optional right side user input control unit 124 receives user inputs to control the dimming level applied at the right side shield unit. In this way, a user may control the level of dimming applied in the right side shield unit 112.

The optional left side user input control unit 110 receives user inputs to control the dimming level applied at the left side shield unit. In this way, a user may control the level of dimming applied in the left side shield unit 118.

The right side user input control unit 124 or the left side user input control unit 110 may control the dimming of both the right side shield unit 112 and the left side shield unit 118. Only one of the right side user input control unit 124 or the left side user input control unit 110 may be provided to control both the right side shield unit 112 or the left side shield unit 118. In an alternative, dimming control may be automated, for example, based on inputs to light sensors, and no user input control unit may be provided to control dimming.

The content control unit 126 may monitor an application implemented on the headset apparatus, or a current state of an application implemented on the headset apparatus, or be provided with information relating to the current application and/or its state, and may control the controller 102 to control one or both of the right the right side shield unit 112 or the left side shield unit 118 in dependence on the current application implemented on the headset apparatus, or a current state of an application implemented on the headset apparatus.

The viewing control unit 128 may monitor a current view of the headset apparatus, or be provided with information relating to the current view of the headset apparatus, and may control the controller 102 to control one or both of the right the right side shield unit 112 or the left side shield unit 118 in dependence on the current view of the headset apparatus.

The location control unit 130 may monitor the location of the headset apparatus or be provided with the location of the headset apparatus, and may control the controller 102 to control one or both of the right the right side shield unit 112 or the left side shield unit 118 in dependence on the location. The location may be an indication of indoors or outdoors.

The timing control unit 132 may monitor the date or time of day or be provided with the date or time of day, and may control the controller 102 to control one or both of the right side shield unit 112 or the left side shield unit 118 in dependence on the date or time of day.

The memory 122 may store computer program code, which when executed by the processor 120 or any other control element such as other elements of the controller 102, cause the headset apparatus to perform operations as described.

There is provided a headset with side dimmers, which may be controlled to vary the amount of peripheral light blocked, in a range of 100% to 0%, which control may be automated according to a variety of conditions, or may be user controlled.

A user may switch a headset from a provision of 100% peripheral blocking, equivalent to having a physical light blocker, to 0% blocking, equivalent to having a full real world peripheral vision and no light blocker, without having to remove the headset apparatus, and without the user being removed from their VR or AR environment by having to remove the headset and physically remove (or add) light blockers. A user may switch between obscured and transparent peripheral vision without needing to remove, add or change a shield.

When using an AR headset in VR mode, peripheral transmission through the side shield may be controlled to be as low as 1%, may be as low as 0.03%, may be as low as 0.01%. The dimmer shield prevents light leakage into the headset from the sides.

Light, or a view of the environment, coming from the periphery may cause one or more of: reflections off the lens optics in the field of view of the user's eyes (e.g., the AR optics), may reduce a pupil size (making the image appear less bright) of the user's eyes, may be distracting to the user, may reduce contrast of the image seen by the user, may add glare to the image seen by the user, and may reduce the sense of immersion or presence for the user. By providing a variable dimmer in the periphery, these problems are addressed.

In applications where a fixed opaque shield that prevents ambient light entering the headset is used, the consequential reduction in peripheral vision may be unsafe, as well as socially uncomfortable. For example, when using a fixed opaque shield, should the product fail or power disconnect, then the user would be in complete darkness. By providing a variable dimmer in the periphery, which becomes transparent in its unpowered state, this problem is addressed.

By providing a variable dimmer in the periphery, other advantages are achieved, e.g., sunlight coming from a left or a right side may be blocked by controlling the dimmers on each side to dim at independent levels.

In more sophisticated arrangements, a portion of one or both of the side shields may be dimmed separately to other portions of the side shield, for example by controlling the dimming level of one or more pixels or segments of the shield, rather than the whole shield. Such dimming control allows the dimming to be varied based on external uneven lighting scenarios or user preferences. Implementations of an electrode layer 176 for such control are described above with reference to FIG. 4.

There are a multitude of ways of achieving spatial or localised dimming, including defining multiple direct-driven segments, by passive matrix addressing, and by active matrix addressing using a TFT backplane. Implementations of an electrode layer 176 for such control are described above with reference to FIG. 4.

There are a multitude of dimming technologies that may be used, including EC, SPD, LC, etc. The disclosed functionality is not limited to a specific dimming technology. Whilst some of these may be driven to a range of grey levels, for those which cannot the same grey effect (e.g., two-state systems) can be achieved by a half-tone approach, by driving only a subset of very small pixels to the opposite state, so that the spatially multiplexed average is grey. The grey levels can be continuous,—which means that for a given dimming technology that has a dimming transmission range from Tmin to Tmax, any intermediate transmission range is also achievable

Current non-AR headsets that shield light from the sides are not biaxially formed, which is desirable for industrial design and consumer acceptance. Biaxial means that the surface of the dimmer is curved in two axes-like around the surface of a sphere.

The side shields may be integrated into the headset frame, or may be removable using a magnet, clip of other mechanical structure. Removable side shields are configured to be electrically connectable to control circuitry when installed.

The side shields as described above are used in a headset apparatus, such as an AR or VR headset apparatus.

Such AR or VR headsets may contain other Liquid Crystal devices in the user's field of view, which may, for example, function as or be used within a switchable lens device or a beam steering device. For example, a device may be or comprise an adaptive optical lens comprising a liquid crystal device according to any of the examples herein. Such a device may be or comprise a headset, which may be referred to as a head-mounted display (HMD).

The liquid crystal device is useful in a wide range of applications, including ophthalmic lenses (such as spectacle lenses), virtual reality (VR), mixed reality (MR), and augmented reality (AR) headsets; optical projectors; photographic devices; and communication devices.

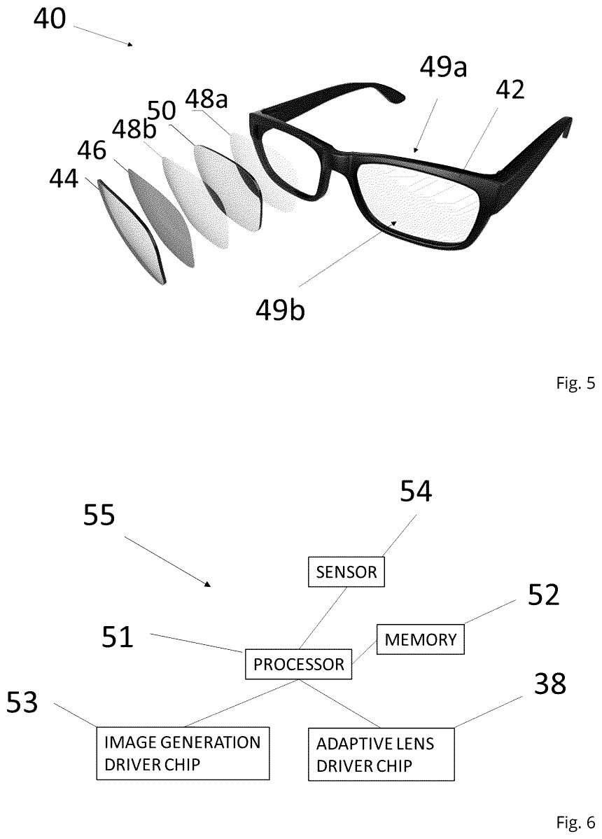

The LC optical lens device may be used for the push lens and/or the pull lens or a combined push/pull lens of an augmented reality (AR) headset such as, e.g., that shown in FIG. 5.

The headset 40 comprises a support frame 42 supporting optical components arranged in optical series in front of the user eye.

At least one optical component, such as one or more of the optical components shown in FIG. 5, may be considered to correspond to or be part of an assembly, which may be considered to be a display stack, comprising at least one liquid crystal cell according to examples herein. In examples, such as that of FIG. 4, such an assembly includes a stack of liquid crystal cells according to examples herein. In the example of FIG. 5, the push lens 48a includes at least one stack of liquid crystal cells, the pull lens 48b includes at least one stack of liquid crystal cells, and the assembly includes the push lens 48a, the waveguide 50, the pull lens 48b, and the variable dimmer device 46, which is an example of a luminance adjustment component, and the front window/lens 44.

Liquid crystal cells of a stack may be aligned along a common optical axis. In some cases, though, optical axes of at least two of the liquid crystal cells of a stack may be offset from each other in a direction parallel to a plane of a radial electrode pattern of at least one of the liquid crystal cells, provided that light traversing the assembly traverses the liquid crystal cells of the stack. FIG. 5 only shows the optical components for one half of the headset for clarity of representation, but a matching set of optical components is also provided for the other half of the headset.

The waveguides 50 of the headset respectively display left-and right perspectives of one or more virtual reality objects, by which the user perceives the one or more virtual reality objects as 3D objects. Alternatively, other mechanisms may be employed to display the left/right perspectives of the one or more virtual reality objects, such as, e.g., laser projection.

The degree to which the user's left and right eyes need to rotate relative to each other such that the left and right perspectives of a virtual reality object are simultaneously directed onto the foveas (which are the parts of the retina responsible for sharp central vision necessary for activities for which visual detail is of primary importance) of respective left and right eyes of the user determines the distance at which the user perceives the virtual reality object to be. This mechanism is referred to as vergence.

Hence, a liquid crystal device according to examples herein may provide a lower complexity and/or higher quality system to actively adjust focus to compensate for focal differences between a virtual object and a real-world environment visible to a user of a headset through the optical components mounted in front of each eye. This, for example, allows the perceived and actual image depth to be brought together in a consistent manner, improving user comfort.

In FIG. 5, the headset 40 permits transmission of light from a real-world environment around the headset 40 at least partly through the optical components and into the user's eyes. In this example, the optical components are at least partly transparent. On a bright day, the luminance of the environment may be significantly higher outdoors than indoors, such as around 100 times higher. This can lead to a virtual object appearing washed out and difficult to see when the user operates the headset outdoors, unless the luminance of the light transmitted from the environment to the user is appropriately controlled. In FIG. 5, the variable dimmer device 46 controls the amount of light transmitted through the optical components and towards the eyes, e.g., so as to reduce the luminance of light from the environment transmitted towards the user in bright conditions and may be used to provide ambient dimming to dim ambient light transmitted through the headset 40.

The variable dimmer device 46 may provide so-called global dimming, in which the luminance of the light from the environment is adjusted by substantially the same amount within an extent of a plane of the variable dimmer device 46 facing the user (e.g., to reduce the luminance of the light by substantially the same amount across an entire surface area of the variable dimmer device 46). In other words, global dimming can allow the luminance of the light transmitted through the variable dimmer device 46 to be controlled in a substantially spatially uniform manner (e.g., so as to provide a substantially spatially uniform reduction in the luminance across a field of view of the user).

The variable dimmer device 46 may also or alternatively provide local dimming, in which the variable dimmer device 46 is adjustable to control the luminance of the light transmitted from the environment on an area-by-area basis (where an area may correspond to a single pixel or a plurality of pixels). Local dimming may involve adjusting the luminance across less than all of the surface area of the variable dimmer device 46, such as within a sub-area which is smaller than the surface area of the variable dimmer device 46. In other cases, though, local dimming may involve adjusting the luminance across the entire surface area of the variable dimmer device 46 but by different amounts in at least two portions of the surface area.

Although not shown in FIG. 5, it is to be appreciated that the headset 40 may be configured to obtain luminance data, e.g., from a light sensor of the headset 40, indicative of the luminance of the light within the environment of the headset 40. For example, if a first side 49a of the headset 40 is configured to face the user, with the headset 40 mounted on the head of the user, the headset 40 may include a light sensor to detect the luminance of light at a second side 49b of the headset 40, opposite to the first side 49a. The variable dimmer device 46 may be controlled at least partly based on the luminance data, so as to adjust the luminance of light transmitted from the second side of the headset 40 towards the user, to improve the visibility of the virtual object displayed to the user by the headset 40.

In the example of FIG. 5, a first lens comprising at least one liquid crystal cell stack of the examples herein (the push lens 48a) is located between the waveguide 50 and the eye, with the headset 40 in use. Light representative of the virtual object is generated and transmitted to the waveguide 50, which directs the light through the push lens 48a and into the eye. The push lens 48a has a focusing effect to focus the light representative of the virtual object so that the object appears in focus to the user. For example, the virtual object may be generated so that it is in focus at a focal plane of infinity. The push lens 48a may then bring the virtual object into focus at a focal plane which is closer to the user than infinity, to allow the user to focus on the virtual object more comfortably. The focal plane at which the virtual object is to be brought into focus, and hence the focusing power to be applied by the push lens 48a, may be determined based on eye tracking data, e.g., obtained by a suitable sensor as discussed further below, which is indicative of a direction in which the eye of the user is looking.

In examples, the liquid crystal device comprises electrical terminals electrically connected to the busbars. The electrical terminals for example allow a potential difference to be applied across the busbars, and thus across each set of concentric rings. As explained above, the electrical potential applied to an electrical terminal can be controlled by a suitable control system.

With reference to FIG. 6, a system 55 according to some examples comprises a processor operating on the basis of computer program code stored in a memory 52 to control an image generation driver chip 53 to cause an image generation system to generate images of left/right perspectives of one or more virtual reality objects, by which the user may perceive 3D images of the virtual reality objects, and display the images via the waveguide 50.

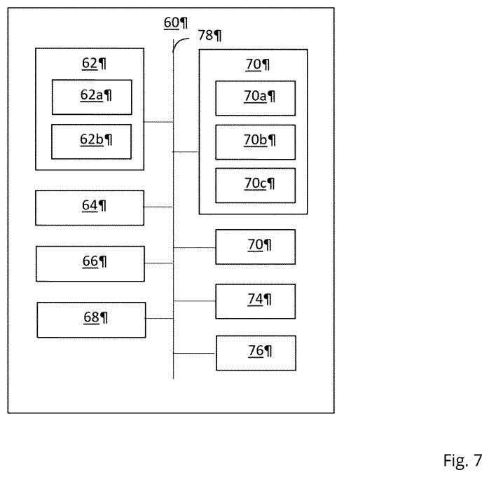

Although not shown in FIG. 6, it is to be appreciated that there may be two waveguides: one to display an image of a left perspective of a virtual reality object to a left eye and another to display an image of a right perspective of a virtual reality object to a right eye, as discussed further with reference to FIG. 6. There may further be two image generation systems: one to generate the image of the left perspective of the virtual reality object and another to generate the image of the right perspective of the virtual reality object (although in some cases a single image generation system may generate both images or an image generation system may generate a single image to be displayed to both eyes). An image generation system is discussed further below with reference to FIG. 7. Inputs from sensors feed into the processor to enable the processor to control positions at which the virtual reality objects are displayed by the waveguides 50, for seamless overlay of the one or more virtual reality objects into the user's view of the user's real environment.

Based on inputs fed into the processor 51 from one or more sensors 54 sensing the movement of the user's eyes and/or based on the content being displayed by the waveguides 50, the processor 51 controls the adaptive lens driver chip 38 to achieve the optical focussing power (Dioptres) required to achieve the above-described generation of optical images of the display output of the waveguides at a distance from the user's eyes at which the virtual content that the user is determined to be looking at (e.g., through tracking of the user's eyes) is intended to be perceived by the user (through the vergence mechanism described above). A driver chip is an example of a controller, which may be implemented in hardware, e.g. via suitably configured circuitry. In some cases, a driver chip may include or be considered to implement at least one processor.

FIG. 7 illustrates schematically hardware architecture of an apparatus 60 according to further examples. The apparatus 60 comprises at least one liquid crystal cell stack in accordance with examples herein. In FIG. 7, the apparatus 60 is configured to be mounted on human head, e.g., a head of a user, with a liquid crystal cell stack positioned in a field of view of an eye of the head, in use. In the example of FIG. 7, the apparatus 60 is an AR headset for displaying a virtual image to a wearer of the headset and may be similar to or the same as the headset 40 of FIG. 5. In other examples, though, apparatus including a similar hardware architecture to the apparatus 60 of FIG. 7 may be configured for a different purpose, may include additional components and/or may omit at least one of the components illustrated in FIG. 7.

The apparatus 60 of FIG. 7 includes an optical system 62, an image generation system 64, at least one processor 66, storage 68, at least one sensor 70, a user input/output interface 72, a communications system 74 and at least one further hardware system 76. Components of the apparatus 60 are connected to each other via at least one bus 78, which may be or include any suitable interface or bus for transferring data between the illustrate components.

The optical system 62 includes a first assembly and a second assembly, which in this example are a first display stack 62a and a second display stack 62b, respectively. The first display stack 62a comprises a first set of optical components, e.g., arranged as a stack of layers. The apparatus 60 is configured to permit at least partial transmission of light from an external environment through the first display stack 62a and towards a first eye of the user, with the apparatus 60 in use and mounted on the head. In other words, where the apparatus 60 has a first side configured to face the user, in use (e.g., the first side 49a of FIG. 5), the first display stack 62a is arranged for directing light from the second side towards the first eye (in this case, through the first display stack 62a). The first display stack 62a in this case includes the optical components shown in FIG. 5, i.e. the push lens 48a, the waveguide 50, the pull lens 48b (where the push and pull lenses 48a, 48b are each an example of a liquid crystal device according to examples herein), the variable dimmer device 46 and the front window/lens 44. The push lens 48a and/or the pull lens 48b of the first display stack 62a may be considered to be a first lens comprising a first at least one of the liquid crystal cell stacks according to examples herein. The first lens is configured to be positioned in a first field of view of a first eye, e.g., the first eye of a user, in use.

In FIG. 7, the second display stack 62b comprises a second set of optical components, which in this example is the same as the first set of optical components but configured to transmit light towards a second eye of the user, with the apparatus 60 in use. In other words, the second display stack 62b is arranged to direct light from the second side of the apparatus 60 towards the second eye. Hence, in this example, the push lens and/or the pull lens of the second display stack 62b may be considered to be a second lens comprising a second at least one of the liquid crystal cell stacks according to examples herein. The second lens is configured to be positioned in a second field of view of a second eye, e.g., the second eye of the user, in use. It is to be appreciated that the first lens may be visible to solely the first eye or to both the first and second eye, in use, and the second lens may be visible to solely the second eye or to both the first and second eye, in use.

A spatial arrangement of elements of the second display stack 62b in at least one layer of the stack may mirror the spatial arrangement of corresponding elements of the first display stack 62a in the corresponding layer of the stack of the first optical arrangement 62a as reflected in a sagittal plane of the apparatus 60 (which may be referred to as a longitudinal plane of the apparatus 60, and e.g., separates left and right sides of the apparatus, with the apparatus in use). In other cases, though, the first and second display stacks 62a, 62b may have a different structure from each other. It is to be appreciated that the optical system 62 may include further components, e.g., further optical components, not shown in FIG. 7.

The apparatus 60 also includes an image generation system 64 to generate an image of a virtual object to be displayed to the user of the apparatus 60 so that the virtual object appears to the user to be overlaid on top of the external environment, which is at least partly visible to the user through the optical system 62. The image generation system 64 may be or include a display device to generate an image (e.g. of a virtual object) for display by the apparatus 60 to the user. The display device may be a liquid crystal display (LCD) device, a light emitting diode (LED) display device such as an organic light emitting diode (OLED) display device, an electroluminescent (EL) display device and so forth. In the example of FIG. 7, the image generation system 64 is in optical communication with the optical system 62. For example, the image generation system 64 may be housed by the support frame 42 if the apparatus 60 is in the form of the headset 40 of FIG. 5. Light generated by the image generation system 62 representing the virtual object may be transmitted to the optical system (e.g., to a waveguide such as the waveguide 50 shown in FIG. 5) either directly (e.g., without traversing another optical component) or via at least one further optical component. In some cases, the image generation system may include two display devices, a first one for the first eye and a second one for the second eye, e.g., if it is desired to display a first image to the first eye and a second image to the second eye. In other examples, a single display device may be used to generate an image to be displayed to both the first and second eyes.

In the example of FIG. 7, the image generation system 64 is shown as a separate system from the optical system 62. In other examples, though, the image generation system may form part of the optical system. For example, an assembly, such as a display stack, of the optical system may include an image generation system, such as a display device.

The at least one processor 66 of the apparatus 60 may be a single processor or a plurality of processors of one or more types. Components of the at least one processor 66 may be implemented using suitably programmed hardware, e.g., in the form of circuitry. The at least one processor 66 may include a central processing unit (CPU), a graphics processing unit (GPU) and/or a neural processing unit (NPU), which may be referred to as a neural network accelerator.

In some examples, an apparatus, such as the apparatus 60 of FIG. 7, includes driving circuitry connected to at least one electrical connection connected to the electrode patterns of the liquid crystal cell stack to apply a potential difference across one or more electrode sets of the liquid crystal cells of the liquid crystal cell stack. The potential difference applied (such as a magnitude and/or timing of the potential difference applied) may be determined by the at least one processor 66 and/or by the driving circuitry, such as by a controller implemented by at least a portion of the driving circuitry, based on the instructions stored in the storage.

If the potential difference is determined by the driving circuitry, the determination of the potential difference may be instigated by instructions received from the at least one processor, such as instructions indicative that a virtual object is to be displayed and that one or more electrode sets are thus to be activated so that the virtual object appears in focus to the user. In this way, the driving circuitry may be agnostic to the at least one processor from which the instructions are received. In other words, the operation of the driving circuitry may for example be independent of the at least one processor used to control the driving circuitry, such that the same effect can be achieved irrespective of the at least one processor coupled to the driving circuitry (provided the at least one processor provides an appropriate indication to the driving circuitry to cause the driving circuitry to determine a suitable potential difference).

The potential difference may be applied to the electrical connection(s) by at least one driver of the driving circuitry, such as the adaptive lens driver chip 38 of FIG. 6, which is an example of a driver. Application of a potential difference by the at least one driver may be considered to amount to so-called “driving” of the electrode pattern(s), via the electrical connection(s). The driving circuitry may be in the form of at least one system-on-a-chip (SoC).

The storage 68 may be or include computer-useable volatile and/or non-volatile memory. The storage 68 may comprise random access memory (RAM) and/or read-only memory (ROM). The storage 68 may be removable or non-removable from the apparatus 60. The storage 68 stores instructions for controlling the apparatus 60 in accordance with examples herein, e.g., to activate one or more electrode sets of the liquid crystal cells of the liquid crystal cell stack. Activation of an electrode set for example refers to applying a potential difference between at least two connectors connected to the electrode set. The instructions may be in the form of computer-readable and/or executable instructions, e.g., computer program instructions. Although the storage 68 is shown as a separate component to the at least one processor 66 in FIG. 7, in some cases the storage 68 may be or include internal storage of the at least one processor 66, in which cases the at least one processor 66 and the storage 68 may be at least partly integrated into the same system or component.

The at least one sensor 70 in this example is configured to obtain eye tracking data of the apparatus, in use, which for example indicates a direction in which at least one eye of the user is looking, as the skilled person will appreciate. Eye tracking data may be obtained for each eye, or the eye tracking data may be obtained for a single eye or for a combination of both eyes of the user. Suitable sensors for obtaining eye tracking data include a camera 70a for obtaining images of at least one eye of the user, an inertial measurement unit (IMU) 70b for determining an orientation of the apparatus 60 and at least one position sensor 70c such as a global positioning system (GPS) sensor to determine a location of the apparatus 60. As the skilled person will appreciate, an IMU 70b may include at least one accelerator or gyroscope for use in determining the orientation of the apparatus 60. The focusing effect of the at least one liquid crystal cell may be controlled based on the eye tracking data, e.g., so as to reduce user eye strain as described further above.

The apparatus 60 also includes a user input/output interface 72 via which a user can interact with the apparatus 60 to control aspects of the apparatus 60. For example, the user input/output interface 72 may be or include an input device such as a button, a touchscreen, a slider, a controller or any other suitable device for communicating user requests to the apparatus 60 to control the apparatus 60.

The apparatus 60 includes a communications system 74 for receiving data from a remote system, e.g., via a suitable telecommunications network, such as a wireless network, or via some other type of network or connection. The communications system 74 may include an input/output interface, such as a Bluetooth connector, a universal serial bus (USB) connector or a network connector, for receiving the data from the remote system.

The apparatus 60 of FIG. 7 includes at least one further hardware system 76 such as a power source, e.g., a battery, for providing electrical power to the electrical components of the apparatus 60.

Some examples have been described above for the example of an optical focussing device, but the same techniques have application in other areas such as, e.g., beam steering optics.

Further examples relate to a method of operating a liquid crystal device according to any of the examples herein.

The term “substantially” used herein may be considered to mean that two elements that are “substantially” the same are: the same within manufacturing tolerances, the same within measurement uncertainties and/or are within 5% of each other.

Examples herein refer to a liquid crystal (LC) material. A liquid crystal material is an example of a material with a switchable refractive index, or a refractive index changing material.

The described device, assembly, and apparatus have use in example implementations other than tuneable lens and optical components. Other example implementations include, but are not limited to: image generation systems, read only memory, network connections, USB, Bluetooth systems, etc., methods of powering and associated techniques. In addition to any modifications explicitly mentioned above, it will be evident to a person skilled in the art that various other modifications of the described embodiment examples may be made within the scope of the invention.

In addition to any modifications explicitly mentioned above, it will be evident to a person skilled in the art that various other modifications of the described embodiment may be made withing the scope of the invention.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

1. An optical device for a headset assembly which is for mounting to a head of a user, the optical device being a side shield for the headset assembly that varies peripheral light entering the headset assembly.

2. The optical device according to claim 1, wherein the side shield is a controllable optical device.

3. The optical device according to claim 2, wherein the optical device is controllable to vary transmission of the peripheral light entering the headset assembly.

4. The optical device according to claim 1 comprising a dimming film mounted on a substrate, the dimming film being controllable to vary the transmission of the peripheral light.

5. The optical device according to claim 4, wherein an antireflective coating and/or a hard coat is formed on either side of the dimming film.

6. The optical device according to claim 4, wherein the dimming film is formed on the substrate.

7. The optical device according to claim 6, wherein the substrate is curved.

8. The optical device according to claim 1, comprising a liquid crystal layer disposed between first and second electrodes, a potential applied between the first and second electrodes determining the transmission of the peripheral light in the optical device.

9. The optical device according to claim 8, wherein one of the first and second electrodes comprises a plurality of individually addressable electrodes, such that the transmission of the peripheral light may be controlled differently in different regions of the liquid crystal layer.

10. The headset assembly according to claim 1 including two optical devices, each of the two optical devices positioned at a side of the headset assembly, the headset assembly further comprising one or more optical lens in a field of a view of an eye of a user of the headset assembly.

11. The headset assembly of claim 10, further comprising a left lens in the field of view of a left eye of the user, and a right lens in a field of view of a right eye of the user, further comprising a controller for controlling the two optical devices positioned at each side of the headset independently to controlling the left lens and the right lens.

12. An assembly comprising:
an optical device for a headset assembly which is for mounting to a head of a user, the optical device being a side shield for the headset assembly which varies peripheral light entering the headset assembly; and
at least one further optical element.

13. The assembly of claim 12, wherein the at least one further optical element is an optical device in a field of view of a user of the headset, wherein the at least one further optical element comprises at least one of: a waveguide, a luminance adjustment component, a lens, an image generation device, a reflection-reduction layer, or a protective layer.

14. The headset assembly comprising the assembly of claim 12.

15. The apparatus comprising the assembly of claim 12, and further comprising:
the optical device for the headset assembly which is for mounting to the head of the user, the optical device being the side shield for the headset assembly which varies the peripheral light entering the headset assembly;
at least one processor; and
at least one storage comprising instructions, the instructions configured to, with the at least one processor, cause the apparatus to control one or more properties of a liquid crystal (LC) layer of the optical device.

16. The apparatus of claim 15, configured to be mounted on a human head with a further optical device cell stack positioned in a field of view of an eye of the human head, a first lens comprising a first one of the LC layer and first electrode, and a second lens comprising a second one of the LC layer and first electrode, wherein the field of view of the eye is a first field of view of a first eye, and the first lens is configured to be positioned in the first field of view, in use, and the second lens is configured to be positioned in a second field of view, of a second human eye of the human head, in use.

17. The apparatus according to claim 15, the apparatus being at least one of an augmented reality display device, a virtual reality display device, or a mixed reality display device.

18. The apparatus of claim 15, the side shield being controlled in dependence on one or more of: an ambient light in an environment in which the headset assembly is used; a light level in a periphery of the headset; a user control input; an application running in the headset; content being viewed in the headset assembly; a location of the headset assembly; a date; or a time of day.

19. A method of operating an optical device for a headset assembly which is for mounting to a head of a user, the optical device being a side shield for the headset assembly which varies peripheral light entering the headset assembly, the method comprising: selectively controlling a light transmission of the optical device.

20. The method of claim 19, wherein the headset assembly further includes a further optical device in the field of view of the user when the headset is mounted to the head of the user, the method further comprising controlling the optical device being the side shield and the further optical device independently.
